(19) United States
(12) Patent Application Publication
(10) Pub. No.: US 2024/0034672 A1
(43) Pub. Date: Feb. 1, 2024

(54) Processes and Methods for the Calcination of Materials

(71) Applicant: CALIX LTD, Pymble (AU)

(72) Inventors: Mark Sceats, Pymble (AU); Adam Vincent, Pymble (AU); Simon Thomsen, Pymble (AU); Matthew Gill, Pymble (AU); Philip Hodgson, Pymble (AU)

(21) Appl. No.: 18/255,507

(22) PCT Filed: Oct. 11, 2021
(86) PCT No.: PCT/AU2021/051183

§ 371 Date: Jun. 1, 2023

(30) Foreign Application Priority Data
Dec. 4, 2020 (AU) 2020904492
Aug. 30, 2021 (AU) 2021902810

(51) Int. Cl. C04B 7/44; C04B 7/02; C04B 7/46; C04B 7/36

(52) U.S. Cl. CPC C04B 7/4407; C04B 7/02; C04B 7/46; C04B 7/367

(57) ABSTRACT

A system for the calcination of powder materials comprising a plurality of vertical reactor tubes in which a falling powder is heated about a heating zone by radiation from the externally heated walls of the reactor tubes, in which the calcination process of the powder may be a reaction which liberates a gas, or induces a phase change; wherein the average velocity of the particles of falling powder during its transit through the reactor tubes is 1.0 m/s or less; the powder material flux for each tube is preferably in the range of 0.5-1 kg m-2 s-1, and wherein the length of the heating zone is in the range of 10 to 35 m.

The present invention relates broadly to the means of calcining materials in a continuous process, where the calcination is described herein is a reaction or a phase change, or both, induced by heating the materials.

There are many processes that have been developed to calcine materials, which have been developed for processing particular materials with particular fuels. The disclosures of this invention relate to a means of fast calcination, known as flash calcination, that uses indirect heating to provide the energy for the reaction of a powdered material.

Most of the prior art for calcination uses direct heating of the materials by a combustion gas, whereas indirect heating transfers heat from the walls of the reactor, generally by radiation heat transfer though a steel tube from an external combustor. There are generally three applications of an indirectly heated process, namely (a) to produce calcined materials with a higher reactivity than direct heating because the short residence time and control of temperature down the reactor reduces internal sintering; and/or (b) to separate the combustion process from the reaction process so that the calcined product is not contaminated by combustion impurities; and/or (c) to separate the gases from combustion process and the reaction processes so that the reaction can be controlled, for example by control of the oxidation state and/or (d), for processing carbonate materials that liberate CO₂ as the calcination reaction to produce oxides, and which enables capture of the process CO₂ gas as a pure gas stream.

With respect to CO₂ capture, there are two sources of emissions from such calcination processes. The first source is CO₂ released from combustion of a carbon based fuels, and is called herein, “combustion CO₂”, and the second source is “process CO₂” that arises from the reaction process, generally from carbonate materials. A low emissions calcination process is directed to the reduction of both combustion and process CO₂. In a life cycle analysis, the use of renewable, or low emissions intensity, electrical power is a means of reducing fuel-side CO₂ emissions. It is projected that the global efforts to reduce emissions will be such the calcined products may be judged by their emissions intensity, in tonnes of CO₂ emissions per tonne of product which includes both fuel and process CO₂. There is a need to reduce the emissions intensity of products made by calcination processes.

There are many established methods for reducing combustion CO₂ emissions. One method of reducing combustion emissions is to use “renewable electric power” produced from wind, solar or other processes to indirectly heat the calciner. The cost of generating renewable power is being reduced rapidly and may become affordable for commodity products. Other methods use low emissions combustion process. One method is to use fuels that are not carbon based, such as such as hydrogen, derived from either “electrolysis” of water, or from the use of carbon based fuels that have been processed by “pre-combustion” capture to remove the CO₂. Another method is to process the flue gas from combustion of carbon based fuels to remove the CO₂ in a process called “post-combustion” capture using a sorbent such as amines, bicarbonates, metal oxides and hydrotalcites. Another method is to use oxygen, instead of air for combustion of carbon based fuels, in a process called “oxyfuel combustion” to produce a flue gas with a high fraction of CO₂ which is readily captured. It would be evident to a person skilled in the art that combustion emissions from calcination can be reduced by using renewable electric power, or electrolysis, or pre-combustion capture, or post-combustion capture, or oxyfuel combustion, or combinations of these to reduce combustion emissions. In most calcination processes that use combustion gases, the hot flue gas is used to directly transfer energy to the material by direct heating, so that any process emissions are mixed with the flue gas, and the extraction of any process CO₂ adds to the cost and complexity of reducing process emissions. On the other hand, indirect heating not only captures process CO₂ as a pure gas steam but also provides flexibility to reduce emissions because any of the low emissions methods described above may be used to provide the heat.

The materials that produce process emissions when calcined are carbonate materials such limestone CaCO₃, dolomite MgCO₃·CaCO₃, magnesite MgCO₃; mixtures of minerals such as required for raw cement meal for the production of Portland Cement in which the carbonate minerals may include impure limestones, such as marls and other mixed metal carbonates, including siderite, FeCO₃; and synthetic carbonate compounds produced for the manufacture of specific oxide materials, including for example, manganese carbonate MnCO₃ produced as intermediates in the production of metals and battery materials; and organic materials which decompose to produce CO₂. There is a wide range of materials that are processed by calcination for a variety of industrial purposes which produce process CO₂.

There is a need to capture either, and preferably both, process CO₂ and combustion CO₂ emissions to reduce the emissions from calcination of materials to mitigate climate change. For example, the cement industry is looking to reduce its CO₂ emissions from calcination of limestone through a number of methods which include using of biomass, waste and renewable electric power as fuels, and a number of CO₂ capture methods that include amine capture, oxyfuel firing, calcium looping, and a process described herein as Direct Separation. The most desirable solution for emissions reduction is a process in which the CO₂ capture is achieved by the lowest cost, in $ per tonne of CO₂ emissions avoided. In many of the proposed capture processes, the cost of CO₂ capture is significant because new chemical and physical processes are required, such as for the amine and oxyfuel methods. In calcium looping, the high mass flows and energy recovery is a barrier to its use. The common theme of each of these processes is that their introduction adds to complexity and cost. An alternative approach, Direct Separation, offers process CO₂ capture at no additional energy penalty or the use of new materials, as has been described by Sceats et. al. in WO2015/077818 “Process and Apparatus for Manufacture of Portland Cement” and references therein. In this approach, indirect heating of the calciner is used so that the process gas stream from processing carbonate minerals is process CO₂, with small amount of impurities from volatilisation of minor constituents. The general approach of calcining carbonate materials using indirect heating has been described by Sceats et. al. in WO2016/077863 “Process and Apparatus for Manufacture of Calcined Compounds for the Production of Calcined Products” and references therein, in which the indirect heating process is extended to the use of different materials and multiple reactor segments, including electrical powered segments.

It is noted that the inventions associated with Direct Separation reactors described in WO2015/077818 and WO2016/077863 and references therein are indirectly heated flash calcination processes, in which the timescale of the calcination process is generally in the range of 10-50 seconds. WO2015/077818 and WO2016/077863 and references therein generally include a general requirement for the input particle size to be typically less than about 100 microns so that the degree of calcination, defined herein as the fraction of the carbonate that is converted to oxide in the reactor in this residence time, is sufficient for the applications of the calcined products. One variable that controls the calcination process in a Direct Separation reactor is the wall temperature distribution, so it is usual to refer to the residence time and the average of this wall temperature as the key variables of the reactor design. In Direct Separation reactors the particles preferably flow downwards under gravity, and the residence time is linked to the terminal velocities of the Particle Size Distribution (PSD) in which the acceleration of the particle fall under gravity is balanced by the gas-particle friction, which depends on the direction of the gas flow.

With respect to residence time and temperature of the reactor, generally, the degree of calcination of the material is preferably at least 95%, or most preferably at least 97% or more. However, in the case of cement meal it may be lower, about 85%, because the subsequent process of clinkerisation may require an endothermic load, such as when rotary kilns are used for clinker production. There is a need for a Direct Separation process in which the residence time and temperature in a reactor segment can be controlled to achieve the desired degree of calcination of a material. The inventions of this disclosure are directed, in part, to increasing the residence time and temperature of Direct Separation reactors.

With respect to the PSD, it is useful to define the three numbers from the measured cumulative volume distribution, namely d₁₀ as the diameter at which 10% of the particles, by volume, are less than d₁₀, d₅₀ in which 50% are less than d₅₀, and d₉₀ in which 90% are less than d₉₀. There are many applications of calcined powders of carbonate materials in which the most preferable d₅₀ size is more than about 100 microns, which has been described in the prior art referenced above. Specifically, products covering the range of about d₁₀ to d₉₀ of 0.1 to 300 microns, each product with a specified PSD within this range.

Powder materials with a d₅₀ exceeding 100 microns are more readily handled than smaller materials with a lower d₅₀, and the products are commonly used in specific powder applications. There is a need to extend the Direct Separation technology to enable the production of such powdered materials into this range.

In other applications there is a need for materials in the form of granules of a millimetre size range, and preferably granules of mixed materials, particularly for applications in mineral processing where entrainment of such products in a gas stream is undesirable, such as slagging for the production of metals such as iron, aluminium and magnesium; and for application in cement manufacturing where clinker formation from the reactions between bound particles in granules occurs in subsequent process steps to form clinker; and for applications in refractory products in which briquettes are made before sintering. There is a need to extend the Direct Separation technology to enable the production of such granulated materials, including the integration of Direct Separation technology into the production of granulated products.

It would be understood by a person skilled in the art that the PSD of calcined material varies considerably for many applications. Specifically, there is a need to reduce emissions for production of such products, so there is a need to apply Direct Separation reactors to process carbonate materials across a broad range of particle size diameters. Large particles fall more quickly through a Direct Separation reactor than smaller particles, so the residence time of larger particles is reduced compared to small particles. In some cases, it may be practical to extend the length of a Direct Separator reactor, described in the prior art referenced above, to achieve this desired degree of calcination. However, it would generally be preferable to use a more compact Direct Separation reactor. The inventions of this disclosure may be directed to a calcination process that can process larger particles than hitherto disclosed for Direct Separation reactors.

The Direct Separation reactors described in WO2015/077818 and WO2016/077863 are described as single tube reactors, where the input materials are typically the order of 8-10 tonnes per hour. For large manufacturing processes, such as cement, the scale up of the reactors is desirable, in the order of about 200 tonnes per hour. There is a need to adapt Direct Separation reactors for such scale up, so that the benefits of the process can be delivered for volume manufacturing.

While the inventions of this disclosure are primarily directed towards reduction of CO₂ emissions for calcination of carbonate materials, and limestone and cement raw meal in particular, the inventions may be applied to the calcination of other materials in which the reaction may be a phase change, or the reactions release gases other than CO₂. Examples of such calcination processes include the removal of moisture, and water of hydration through the production of steam, the volatilisation of sulphur compounds, ammonia and acid gases such as HCl.

The project leading to this application has received funding from the European Union's Horizon 2020 research and innovation programme under grant agreements No. 654465 and 884170.

### BACKGROUND

The inventions described in this disclosure have been primarily derived from observing and understanding the calcination of materials containing calcium carbonate (CaCO₃) in Direct Separations reactors to produce lime (CaO). Such inventions described herein may be considered to be improvements of WO2015/077818 and WO2016/077863 and references therein, for processing such materials. Further, inventions disclosed may be applied to Direct Separation reactors to scale up the process, to facilitate the integration of Direct Separation reactors into industrial processes, and to process other materials in Direct Separation reactors for any purpose.

It would be understood be a person skilled in the art that the processing of calcium carbonate containing materials, including limestone, dolomite and cement meal is that that the freshly calcined lime particles are “sticky”. Early references to this property comes from historical documents from lime burners, and the consequences impact on the design of modern production processes which produces significant amounts of CaO. There is a very large literature on the subject which is summarised below.

Lime stickiness is associated with the formation of agglomerates of particles, the formation of deposits on cold surfaces, the sticky properties of beds of the material, and the challenges of conveying of the product. The physical origin of the stickiness is associated with the high surface energy of the CaO produced in the calcination reaction fronts that move through the particle. Without being limited by theory, the calcination reaction produces CaO grains that are order of 20 nm in size, with a surface area of more than 100 m²/g. These small grains have a high surface energy which is spontaneously reduced through a sintering process at high temperature in which the grains grow to greater than 100 nm through a process known as Ostwald ripening, which is initiated by the formation of necks between adjacent CaO grains, followed by diffusion of CaO through these necks, so that the smaller grains are absorbed into larger grains. This grain coarsening process reduces the surface energy as the grain size increases. From the perspective of the pores between the grains, there is a transfer of porosity from mesopores of 5-10 nm to macropores of greater than 100 nm. The literature describes such sintering through a range of mechanisms through which the sintering rate increases not only with temperature, but also with CO₂ and H₂O partial pressures, because sintering is catalysed by these gases. The catalysis is such that CaO can migrate quickly over length scales of microns. The diffusion of CaO is important for processes such as ceramics and cement manufacture, for slagging of minerals, and the impacts on flash calcination as described below.

The origin of the “stickiness” of such lime particles is that the necks also grow between colliding particles, or particles adhered on a surface, or packed in a bed to reduce the surface energy. The physical sintering processes of grains within a particle is not differentiable from the adhesion of particles that are in physical contact. In the literature of ceramics, cements and slagging processes, the word “sintering” is applied to processes both within and between particles In this invention, a relevant aspect of stickiness is the process of “agglomeration” in which particles adhere during the calcination process to an extent that the processing of the agglomerate through the reactor is significantly different from the individual particles, and further that the process of “cascading agglomeration” occurs in which agglomerates adhere. Without being limited by theory, it is understood that (a) agglomerates form from particle-particle collisions in clusters of particles which are created in Direct Separation reactors to minimise gas particle friction and (b) agglomerates are formed more readily in conditions when there is stronger gas-particle turbulence which increases the collision rate between particles in a cluster, and (c) the strength of the adhesion, and its persistence, are a result of the sintering process, and (d) the impact of the persistence of agglomerates on the calcination process may be significant.

Of relevance to Direct Separation reactors, the prior art on CaO sintering also describes the catalytic sintering of the CaO by CO₂, in which the initial stages of sintering occur within 30 seconds at temperatures greater than about 800° C. and CO₂ partial pressures above about 5 kPa. Since this sintering time is comparable to the residence time of 10-50 seconds typically used in Direct Separation reactors, where the CO₂ partial pressure is the order of 100 kPa and the temperature is the order of 900° C., it is reasonable to expect that any CaO produced in such Direct Separation reactors would be sintered to give a surface area lower than about 20 m²/g. This has been confirmed in Direct Separation reactors. Because sintering occurs on the residence time of particles in the reactor, it would be expected that the effects of “stickiness” between particles will also be apparent, and may impact on the performance of a Direct Separation reactor in processing materials that produce CaO in the presence of CO₂. This disclosure focusses on inventions that either mitigate adverse effects, or that take advantage of the effects to produce novel materials.

One object of the present inventions may be to provide one or more means of optimising the design of Direct Separator tube reactors to control the impacts of lime stickiness.

Another object of the present inventions may be to provide a means of scaling up Direct Separation reactors to larger production capacity.

Another object of the present invention may be to describe the use of the present inventions to integrate Direct Separation reactors into industrial applications, with specific applications to the production of Portland Cement, iron, aluminium and magnesium metal.

Another object of the present inventions may be the application of these inventions to processing other materials where the benefits are in a simplification of the process in terms of operations and complexity, or improved properties of the materials.

Any discussion of the prior art throughout the specification should in no way be considered as an admission that such prior art is widely known or forms part of common general knowledge in the field.

### SUMMARY

The inventions of this patent are generally associated with improvements of Direct Separation technology.
(a) Such inventions include a system for the calcination of powder materials comprising one or more reactor tubes in which a falling powder is predominately heated by radiation from the externally heated walls of the tube, in which the calcination process of the powder may be a reaction which liberates a gas, or induces a phase change, or both; the average velocity of the powder during its transit through the reactor is 1.0 m/s or less and preferably less than 0.2 m/s; the powder material flux for each tube is preferably in the range of 0.5-1 kg m⁻² s⁻¹, and the length of the heating zone is in the range of 10 to 35 m.
(b) A means of processing larger particles, above 100 μm using a counterflow of particles and gas;
(c) A means of reducing agglomeration and clustering by reducing gas particle turbulence by using a co-flow of particles and gas;
(d) A means of cooling the calcined particle stream from a Direct Separation reactor and heating the ambient particle streams for injecting the particles into a Direct Separation reactor using a counter-flow tube systems, and for lime using the preheating system to partially calcine and passivate the particles to inhibit agglomeration and fouling when the particles are injected into a Direct Separation reactor;
(e) A means of efficiently external heating the reactor walls using closely integrated combustor furnace segments, flameless combustors with various fuels and electric power heating, and in the case of carbon based fuels, using post combustion processes to capture the CO₂ to minimise energy consumption and CO2 emissions.
(f) A means of using segmented tubes to enable (i) the optimisation of the process energy consumption by switching the process gas pressure, (ii) to inject hot gases and fuels/air and (iii) production of products through an optimised sequence of chemical reactions, such as the production of Ca(OH)₂ from CaCO₃
(g) A means of thermally granulating lime using the adhesion from CaO in CO₂, including mixing the lime with other minerals to that the granules may be used industrial processes where slagging or clinkering is important, such as the production of iron, aluminium with CaO, and magnesium metals from dolime MgO·CaO.
(h) A means of scaling up the process using a number of tubes

### Problems to be Solved

The first problem to be solved is to optimise Direct Separation reactors for processing materials that produce particles that comprise CaO, and especially CaO particles in the presence of CO₂.

The second problem to be solved is to optimise Direct Separation reactors to scale up the process to larger throughputs.

The third problem to be solved is the integration of Direct Separation Reactors into a number of industrial processes.

The fourth problem to be solved is the improvement of Direct Separation reactors for calcination of a wide range of materials.

### Means for Solving the Problems

In a first aspect of the present invention, there is described a number of measures that reduce the formation of CaO-induced agglomerates of particles injected into a Direct Separation reactor, and reduce the fouling of the metal surfaces through which the heat is transferred, and reduce the propensity of beds of these particles to resist fluidisation for transport. There are three solutions described, The first solution is one in which larger CaO particles may be processed to take advantage of the observation that agglomeration is reduced when larger particles are calcined. The second solution is one in which agglomeration of CaO particles is reduced by minimising the collision frequency between particles. The third solution is to reduce the propensity of such CaO particles to stick during a collision.

In a second aspect of the present invention, there is described a means of promoting agglomeration of CaO particles produced from a Direct Separation Reactor that uses the inventions described in the first aspect to make products that require granules of the material for use in subsequent processes, Such processes include the production of Portland Cement from the calcined cement meal produced in Direct Separation reactors; for the production of magnesium metal using the Pidgeon process from dolime MgO·CaO produced in a Direct Separation reactor; and for the production of low emissions lime granules produced in a Direct Separation reactors for injection into slagging processes used in the production for example, of steel and aluminium to remove impurities such as silicates.

In a third aspect of the present invention, there is described a number of measures of integrating a Direct Separation reactor into an industrial process. These measures include the means of preheating input powders using waste heat, injecting the powder into the reactor, providing heat to the reactor walls, extracting the process gas stream from the reactor, minimising the loss of solids in the exhaust gas, and measures to cool the product. The primary need for this aspect is to provide the measures which minimise the energy required to process a material, which is generally provided at ambient conditions, and deliver a powder product and exhaust gas streams at the required conditions with a preferably minimal energy consumption.

In a fourth aspect of the present invention, there is described a number of measures that enable the scale up of the production capacity of a system that uses Direct Separation reactors. There is a reasonable limit to the diameter of Direct Separation reactor tubes associated with the penetration depth of radiation into the mix of particles and gas. Thus a scale up of the production capacity is primarily through an array of tubes. The measures of scale up include a means for distribution of preheated solids to a number of tubes, a means for heating the powder in separate tubes in a furnace from combustors, and aggregating the powder streams and gas streams from the reactor tubes for subsequent processing. The primary need for this aspect is to provide the measures which minimise the energy required to process a material, which is generally provided at ambient conditions, and deliver a powder product and exhaust gas streams at the required conditions with a preferably minimal energy consumption, to achieve an economy of scale.

In a fifth aspect of the present invention, specific process steps are proposed that facilitate the integration of Direct Separation reactors into manufacturing processes, with a primary application being for the production of cement clinker.

In a sixth aspect of the present invention may relate to a system for the calcination of powder materials comprising a plurality of vertical reactor tubes in which a falling powder is heated about a heating zone by radiation from the externally heated walls of the reactor tubes, in which the calcination process of the powder may be a reaction which liberates a gas, or induces a phase change; wherein the average velocity of the particles of falling powder during its transit through the reactor tubes is 1.0 m/s or less; the powder material flux for each tube is preferably in the range of 0.5-1 kg m⁻² s⁻¹, and wherein the length of the heating zone is in the range of 10 to 35 m.

Preferably, the powder materials comprise compounds or minerals which when heated, liberates a gas, wherein the gas is at least one selected from the group of: carbon dioxide, steam, an acid gas such as hydrogen chloride, and an alkali gas such as ammonia.

Preferably, the mineral is limestone or dolomite.

Preferably, the compounds include silica and clays, such that the powder material is a raw cement meal for the manufacture of Portland cement.

Preferably, the particle volume distribution of the powder material is limited by 90% less than 250 μm diameter and 10% higher than 0.1 μm.

Preferably, the liberated gas flows upwards in the tube against the flow of the calcining powder and wherein the gas is exhausted at the top of the system.

Preferably, the liberated gas, and any gas introduced into the system flows downwards in the reactor tube with the flow of the calcining powder and wherein the gas is exhausted at the base of the system.

Preferably, an inner tube is placed in each tube and the powder material flows downwards in a reaction annulus with the liberated gas; and wherein at the base of the reactor, the gas flow is reversed to flow up through the inner tube and the liberated gas and any gas introduced into the system is exhausted at the top of the system.

Preferably, the powder material entrained in the exhausted gas is separated and reinjected into the system.

Preferably, the injected powder is preheated in a gas-powder preheater system prior to injection into the system.

Preferably, the gas-powder preheater system is one or more refractory heating tubes in which the cold powder material falls through a hot rising gas and is heated by the rising gas, in which average velocity of the powder during its transit through a preheater tube is 0.5 m/s or less.

Preferably, the exhausted powder from the base of the system is cooled in a gas-powder cooling system.

Preferably, the gas-powder cooling system is one or more refractory cooling tubes in which the hot powder material falls through a cool rising gas, in which average velocity of the powder during its transit through a cooling tube is 0.5 m/s or less.

Preferably, an external heating system for externally heating walls of the tube is an integrated combustor and furnace system which enables the control of the temperature profile down the heating zone of the system.

Preferably, the external heating system is a flameless combustion system which enables the control of the temperature profile down the heating zone of the system.

Preferably, the fuel for the external heating system is at least one gas selected from the group of: natural gas, syngas, town gas, producer gas, and hydrogen; and wherein the combustion gas is air, oxygen or mixtures thereof which have been heated from flue gases of the external heating system.

Preferably, CO₂ in the flue gas is extracted using a regenerative post-combustion CO₂ capture system, which is at least one selected from the group of: an amine sorbent system, a bicarbonate sorbent system, and a calcium looping system.

Preferably, the external heating system is an electrically powered furnace, where the power is generated from hot gas streams in a production plant of which the system is a part, or extracted from the grid, and configured to enable the control of the temperature profile down the heating zone of the system.

Preferably, the external heating system is a combination of any one of the external heating systems of Claims 14, 15 and 18, which may be applied to different segments of each tube or different tubes, and the operation of the system can use a variable combination of such external heating systems while maintaining continuous production of calcined materials.

Preferably, the powder material is injected into the reactor tubes at a number of depths.

Preferably, each tube is segmented into a plurality of segments mounted in series, in which the gases liberated or introduced in each segment is withdrawn from that segment using a gas-block between segments.

Preferably, the partial pressure of the gas liberated during the calcination in a higher segment may be reduced in the segment below so that the reaction proceeds further by the partial pressure drop so as to achieve a new equilibrium at the lower partial pressure, including a drop in the wall temperature of the lower segment so that any thermal energy stored in the partially calcined powder from the higher segment is used for calcination.

Preferably, the wall temperature of each segment increases sequentially in each segment from the upper segment so that the gas liberated from each segment can be a specific gas of a desired purity, and other gases may be added to each segment to promote catalysis of the reaction step and/or sintering of the materials during the reaction step.

Preferably, the system makes sintered MgO for refractory blocks from magnesite.

Preferably, the system produces Ca(OH)₂ or Mg(OH)₂ from limestone or magnesite.

Preferably, the system controls the oxidation state of battery precursors.

Preferably, each tube is segmented into a number of segments, in which the gases liberated or introduced in each segment is withdrawn from that segment using a gas-block between segments and a hot gas stream is introduced into a segment to boost the thermal energy of the gas and particles in that segment to augment the thermal energy provided by external heating.

Preferably, the gas stream contains a combustible fuel and oxygen or air for combustion to induce combustion in that segment to boost the thermal energy of the gas and particles in that segment to augment the thermal energy provided by external heating in that or other segments.

Preferably, the temperature rise from combustion is sufficient to induce particle-particle or intraparticle reactions typical of roasting or clinkering reactions which subsequently occur in the powder bed formed at the base of the segment wherein the energy released from exothermic reactions can sustain or increase the temperature of the powder bed so that the induced reactions are sufficiently complete during the residence time in the powder bed.

Preferably, the preheating temperature of the gas-powder preheater system is in the range of 650 to 800° C., and the partial pressure of the gas liberated during calcination is below 15 kPa so that the powder material is partly calcined and then sintered such that the surface energy of the particle is reduced sufficiently so that the propensity of the particles to subsequently bind and agglomerate is reduced.

Preferably, the material is limestone where the calcined material, or mixtures of calcined material with other minerals, is introduced into post-processing system to produce granules of the materials, in which the granules are formed by agitating the powders and wherein the gas environment contains carbon dioxide, in which the temperature of the granulator system is in the range of 650 to 800° C. that recombination of the lime with CO₂ is suppressed.

Preferably, the material is to be first calcined in a first segment using steel reactor walls to provide heat to the system and the gas liberated or introduced in each segments is withdrawn from that segment using a gas-block between this first segment and the lower segment, so that a second gas stream of a different gas may be injected into the second segment and heat transfer through the reactor wall in the second segment is controlled so that the calcined powder from the first segment reacts with the gas to produce a new material compound.

Preferably, the powder material is limestone, CaCO₃, or dolomite CaCO₃·MgCO₃, in which the calcined product from the first segment is lime CaO or dolime CaO·MgO and wherein the exhausted gas is CO₂, and the gas injected into the second segment is steam H₂O and the temperature is controlled by the removal of heat through the wall so that hydrated lime is exhausted from the second segment and the diameter of the tubes in the system are selected such that the residence time allow the heat transfers and the reaction kinetics to be balanced with a minimal segment length.

Preferably, the hydrated lime or dolime product has a high reactivity with CO₂ in ambient air to reform CaCO₃ or MgCO₃·CaCO₃, and where this product is reintroduced into the system so as to remove CO₂ from ambient air in a cyclic system, and wherein when the product is used with renewable fuels and with combustion CO₂ capture, the system produces a carbon negative emissions product.

Preferably, the reactor tubes are vibrated to remove the build-up of solid materials adhered to the walls of the system.

Preferably, the heat from the external heating system to each tube is separated by a refractory wall such that the plant can operate with any number of tubes in an efficient manner through the use of refractory materials and energy distribution, including gas and radiation, which controls the exposure of any tube to radiation and convection transfer of heat so that the temperature profile are controlled within desirable limits linked to thermal stresses of the metal tube, and energy consumption by the system.

Preferably, the preheater segment and/or the cooling segment requires the distribution of preheated materials from a central preheater to each tube which is accomplished by at least one of the group of: an L-valve, an assembly of L-valves designed to provide a controlled distribution of powder to each tube, an aggregator system of the hot calcined materials from each tube to a central cooling system, and a central subsequent processing system such a kiln where the aggregation is accomplished by a system of gas-slides where the flows of hot calcined powder are controlled to provide a continuous flow of materials.

The solutions to the problems may be drawn from a number of these aspects.

Further forms of the invention will be apparent from the description and drawings.

### BRIEF DESCRIPTION OF THE FIGURES

Embodiments of the invention will be better understood and readily apparent to one of ordinary skill in the art from the following written description, by way of example only, and in conjunction with the drawings, in which:

FIG. 1 is a schematic of an example embodiment wherein the residence time of preferably large particles in a Direct Separation reactor is enhanced by the counter-flow of the process gas stream to reduce the terminal velocities of the particles. Any undesirable effects from CaO inducing particle-particle binding is reduced by the use of sufficiently large particles, which have a low propensity to bind.

FIG. 2 is a schematic of an example embodiment for preferably calcining small particles where CaO induced particle-particle binding is limited by the use of a co-flow of particles and the process gas with gas-particle separation occurring in the base of the reactor by a separator.

FIG. 3 is a schematic of an example embodiment for preferably calcining small particles where CaO induced particle-particle binding is limited by the use of a Direct Separation reactor design that has a central tube, where the reaction occurs in the low turbulence co-flow of particles and gas down the annulus, and the process gas is exhausted through the centre tube, wherein the gas-particle separation occurs at the base of the reactor by a reversal of the direction of the gas flow.

FIG. 4 is a schematic of an example embodiment for preferably calcining small particles where CaO induced particle-particle binding is further reduced from that of the designs described in FIG. 1-3 by in which partial pre-calcining, controlled agglomeration and sintering is carried out prior to injection in the reactor.

FIG. 5 which the powder is injected into the reactor zone at several depths to mitigate the effects of agglomeration.

FIG. 6 is a schematic embodiment in which the powder exhaust from any of the Direct Separator reactor configurations of FIGS. 1-5 is and agitated to produce a ball of agglomerates of a desired size, in which the compression strength of the granules is sufficiently strong for particular applications.

FIG. 7 is a schematic of an example embodiment in which the partially calcined powder from a first reactor segment is injected into a second reactor segment where the gas stream is injected into the second reactor segment.

FIG. 8 is a schematic of an example embodiment for particular application to the production of cement clinker in which the powder exhaust from the Direct Separation reactor is processed in several steps to produce cement clinker by flash heating of the powder by direct heating of the falling powder to provide sufficient energy that the clinkerisation reactions may commence, and the heated at the base of the reactor falls into a moving bed where the exothermic clinkerisation reactions proceed and which further heat the bed so that clinker is rapidly formed in that bed. Other industrial applications for this general process are described.

FIG. 9 is a schematic example of an example embodiment of a counterflow Direct Separation reactor of FIG. 1 for the processing of limestone in which the furnace heat is provided by a flameless regenerative combustion process; the fuel is Syngas produced from biomass; the CO₂ is extracted from the flue gas; the heat from the product solid and process gas streams is used to preheat the powder input using a counterflow heat exchangers. The intent of this embodiment is to illustrate that this system can provide a high thermal efficiency with complete process and combustion CO₂ capture to give an overall carbon negative emissions product.

FIG. 10 is a schematic of an example embodiment of a module of Direct Separation reactors in which the reactors of any of FIGS. 1-10 are housed in a single furnace where the radiation and convective coupling of the tubes is controlled by the use of refractory elements within the furnace, and the majority of the product preheating and cooling is carried out using the ancillaries described in FIG. 10 for each tube.

FIG. 11 is a schematic of an example embodiment of a module of Direct Separation reactors in which the reactors of any of FIGS. 1-11 are housed in a single furnace where the radiation and convective coupling of the tubes is controlled by the use of refractory elements within the furnace, and the preheating and post processing of the materials is carried out using module-scale systems necessitating the distribution of preheated powder and calcined powder from such module scale systems to and from the tubes.

### DESCRIPTION OF THE INVENTION

Preferred embodiments of the invention will now be described by reference to the accompanying drawings and non-limiting examples.

With reference to the first aspect associated with the reduction of CaO agglomerates, the principles have been developed based on a knowledge of gas-particle hydrodynamics considered below. In all the embodiments described below the particles flow down the Direct Separation reactor against gravity.

To inhibit the formation of agglomerates, the preferred approach is to increase the mean particle size for a fixed mass flow rate. The basis rationale is that the number density of particles is greatly reduced, so the particle-particle collision rate is reduced, and in addition, the momentum from particle-particle collisions is sufficiently large that the necks of CaO produced during a collision are insufficiently strong and fracture, so the colliding particles rebound instead of sticking. The prior art for Direct Separation reactors generally considers particles to be the order of 20 μm, and generally less than 100 μm. An object of the inventions disclosed herein is to increase the particle size to about 250 μm. There are three factors that lower the degree of calcination that can be achieved for such large particles. Firstly, the residence time of the particles is reduced because the particles reach a higher terminal velocity from their higher mass; secondly the adsorption of radiation by the particles from the hot wall is reduced because the mean surface area is reduced; and thirdly, for many materials which have a low porosity, the time it takes for the reaction front to move from the surface to the centre of the particles is longer for larger particles. One solution is simply to increase the length of the reactor so that the residence time increases. However, in many cases this solution is not practical. Another solution is to increase the wall temperature of the reactor so the heat transfer rates are faster. However, in many cases the steel of the reactor tube is unable to withstand the higher temperature because of the loss of strength of the steel and acceleration of corrosion mechanisms. New steels may alleviate such effect.

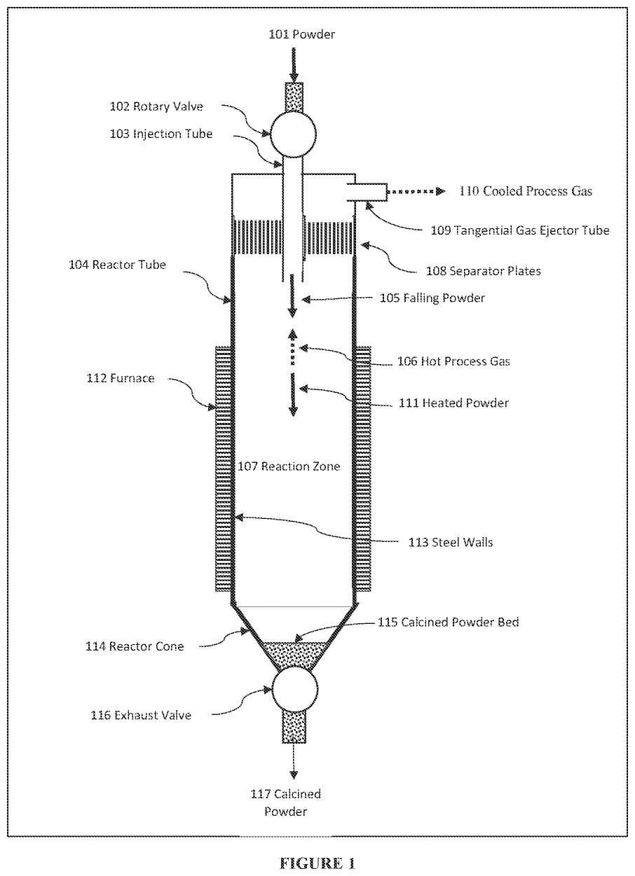

Another solution is illustrated in FIG. 1, where the residence time can be reduced by using a counterflow configuration in which the particle terminal velocity is reduced by the gas particle friction against the rising gas produced from the reaction. In FIG. 1, a Direct Separator Reactor with counterflow is described in which a powder feed 101 is injected into the reactor system by a rotary valve 102 into an injector tube 103 into the reactor tube 104. The falling powder 105, in a plume, is heated towards the reaction temperature by the hot rising process gas stream 106 rising from the reaction zone 107 by gas-particle heat transfer by virtue of the counterflow. The cooled gas is separated from any entrained powder by a system comprising a system of separator plates 108 and a tangential gas ejector tube 109 to give a cooled process gas stream 110. Any powder in this gas stream is extracted by a cyclone/filter system (not shown) and reinjected into the reactor. The heated powder 111 in the reactor falls slowly against the rising gas and enters the reaction zone 107 where it is heated by radiation from the reactor walls where the heat is generated within a furnace 112 which heats the steel walls 113 and the heat flows to the gas and particles in the reactor to induce the desired reaction. The length of the heating zone is sufficient for the reaction to be completed to the desired degree. The falling hot calcined powder is collected in the reactor cone 114 and forms a hot calcined powder bed 115 which is extracted from the reactor by an exhaust valve 116, which may be a system of flap valves to give a calcined powder stream 117. An advantage of this configuration is that the heat transfer between the falling particles and the rising hot gas is to heat the particles so that the process is not as reliant on external heat exchangers to achieve a high thermal efficiency. It is noted that in many cases that this approach may not appear effective, because particles of such a mass and size are, in principle, readily ejected from the reactor. However, it is known that the slipstream of large particles shows a strong gas eddy behind the falling particle, such that there is a tendency of the particles to form clusters which minimise the gas particle friction so the cluster flows down the tube against the rising gas. In addition, the re-injection of any entrained particles into the reactor is such that the mass of particles accumulated in the reactor grows to a point where the particles have sufficient mass density that they organise as clusters to break through the upflowing gas. At high mass flow rates, the clustering of the particles is sufficient that the momentum of the clusters leads to a more laminar flow regime by the fast exchange of particles between clusters, so that large-scale turbulence may by suppressed, with the added advantage that the growth of fouling may be suppressed by such momentum as the particles flow against the wall to minimise the gas-particle friction. Further, it is noted that no process gas is created if no particles are injected into the heating zone of the reactor. Thus, a condition is always formed in which the particles must flow down the reactor. One effect of the configuration of FIG. 1 is that pulsations may occur of the mass flow through the reactor, and any such effects may be controlled by the reactor and the cyclone/filter settings. Another advantage of the configuration of FIG. 1 is that the particle flow into the base of the reactor is not impacted by a gas flow, and because the larger particles in the bed of the reactor are not subject to significant agglomeration as small particles, the conveying and transport of the particles from the reactor is not inhibited. It has been found that a small injection of preferably hot steam, or air, at the base may be used to control any such agglomeration. The steam or air in the gas CO₂ gas stream is condensed or removed during the compression process using standard processes. It is preferable that these gases are less than 10% of the process gas stream, and most preferably less than 5%. Such a hot gas may also regulate the residence time of the powder, and if the gas is preferably steam or air, the reduction of the partial pressure may increase the degree of calcination by a reduction of the equilibrium pressure of the calcination reaction. Further, in the case of calcination of carbonates, the displacement of CO₂ at the reactor base can reduce residual particle agglomeration in the bed at the base of the reactor to facilitate fluidisation and reduce effects like rat-holing.

Another advantage of the configuration of FIG. 1 is that the low strength of particle-particle bonds between larger particles is such that fouling of the tube surface to limit heat transfer is less than observed for small particles. Experiments show that the vertical surface of the tube is self-cleaning for both small and large particles, and sections of coated surface sloughs off at high temperatures suggesting that the strength of the interparticle bonds are sufficiently weak to support a thick coating, so the fouling is typically less than 1 mm thick. It is found that the thickness of the coating, as measured by the temperature drop between the inner steel wall and the exposed coating surface decreases as the particle flux increases, as may be expected from the increased shear forces created by the higher momentum of the solids which dislodges the coating. This is a characteristic of the all the configurations disclosed below. The thickness however, depends on the embodiments described herein, and the learning is that suppression of agglomeration is correlated with a lower coating thickness.

It is noted that this configuration of FIG. 1 may be generally applied to the calcination of materials in which there is little tendency for the large particles to agglomerate. The longer residence time and the low loss of powder due to clustering in counterflow is generally a benefit. In applications where the process is a pyroprocessing phase change, the injection of gas at the base may increase the residence time, and that gas may be chosen as one which catalyses the phase change. An example is the processing of α-spodumene to β-spodumene to extract lithium, and the catalyst is steam.

There are many cases in which it is not possible to increase the particle size of the powder input, so that approach of the embodiment of FIG. 1 is not possible. It has been observed that when small particles are injected into a Direct Separation reactor, that there may be multiple effects that are encountered when CaO is formed by calcination. These include an increase in the fouling of the hot steel reactor surfaces that creates a resistance to the heat transfer of radiation for the walls into the bulk of the reactor, an increased resistance of the powder collected in the base of the reactor to flow, and the formation of large agglomerates that form in the reactor that fall through the reactor sufficiently fast that the degree of calcination is reduced. As described above, all these effects can be attributed to the stickiness of the lime produced during calcination. The formation of large granules of lime, up to several mm is size may be formed, in which case the process is called “cascading agglomeration” because large agglomerates of this size are formed by agglomeration of agglomerates. In other conditions the size of the agglomerates is smaller, say about 100-150 μm. While such conditions may be found and the calcination of such agglomerates may achieve a desired degree of calcination, the onset of cascading agglomeration from limited agglomeration is difficult to manage, and this is undesirable for quality control.

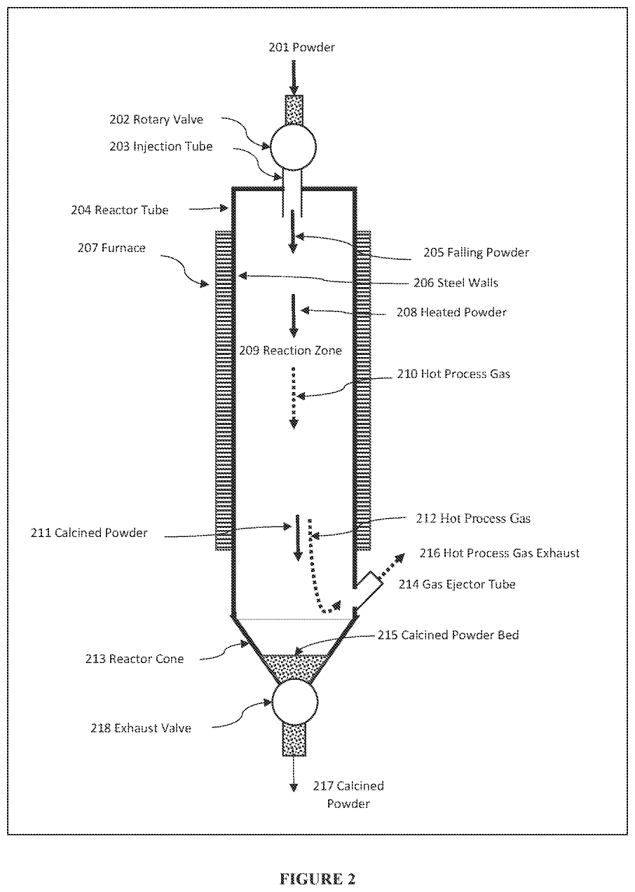

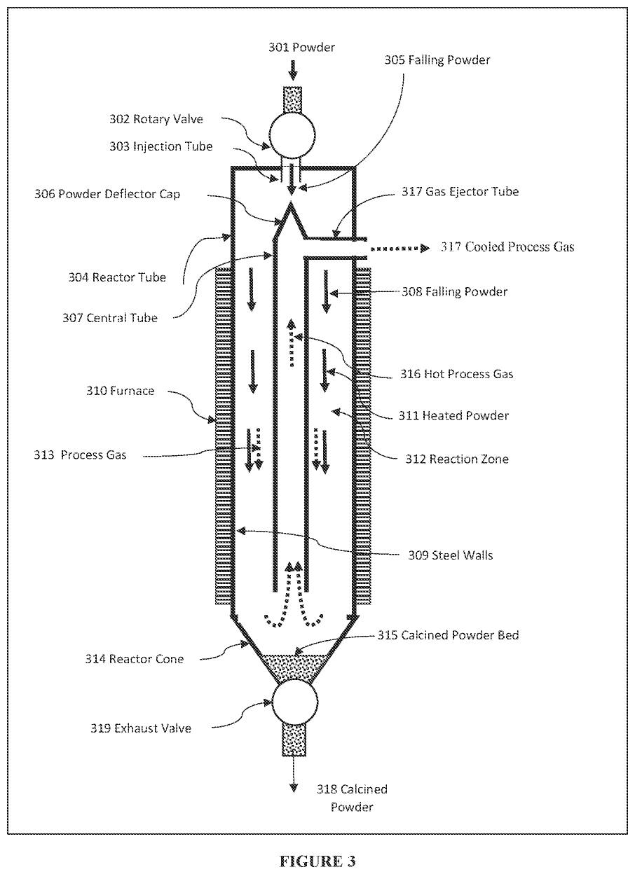

The principle for reducing agglomeration is to minimise the turbulence of the gas particle flows on all length scales, because high turbulence maximises the particle-particle and particle-wall collision frequency and, the suppression of turbulence limits the formation of agglomerates. The embodiments of FIGS. 2 and 3 provide examples in which agglomeration may be controlled by minimising the turbulence. FIG. 2 described a co-flow system in which the process gas stream is exhausted at the base of the reactor and FIG. 3 describes a system in which the process gas stream is exhausted through a central tube whereby the gas stream is exhausted at the top of the reactor.

In FIG. 2, a Direct Separator Reactor with co-flow is described in which a powder feed 201 is injected into the by a Rotary Valve 202 into an Injector Tube 203 into the Reactor Tube 204. The falling powder 205, in a plume, is heated towards the reaction temperature by radiation from the steel reactor walls 206 which heats the gas and particles, where the heat is generated within an external furnace 207 which heats the steel walls. The heated powder 208 falls deeper into the reactor into reaction zone 209 where the radiation heat from the walls is absorbed and induces the desired reaction. As the reaction proceeds, the hot process gas 210 accelerates the particles through the reactor by virtue of the co-flow. The length of the heating zone is sufficient for the reaction to be completed to the desired degree. The calcined powder 211 and the hot process gas 212 are exhausted from the base of the reactor. These gas and particle streams are separated by the reactor cone 213, the gas ejector tube 214 and the powder bed 215 acting as an inertial separator which forces the hot process gas steam 216 to be ejected from the reactor and the powder to be deposited in the powder bed. The hot powder stream 217 is exhausted from the reactor by the exhaust valve 218, which may be a system of flap valves. Any powder in this gas stream is extracted by a cyclone/filter system (not shown) and reinjected into the reactor.

In FIG. 3, a Direct Separator Reactor with co-flow is described in which a powder feed 301 is injected by a Rotary Valve 302 into an Injector Tube 303 into the reactor tube 304. The falling powder 305, in a plume, is defected by a defected cap 306 into a reaction annulus, formed by a hanging central tube 307 (the suspension of which is not specified). The falling powder 308 is heated towards the reaction temperature in the annulus by radiation from the steel walls 309 heated by the furnace 310. The heated powder 311 falls deeper into the reactor into reaction zone 312 where the radiation heat from the walls is absorbed and induces the desired reaction. As the reaction proceeds, the hot process gas 313 accelerates the particles through the reactor by virtue of the co-flow. The length of the heating zone is sufficient for the reaction to be completed to the desired degree in the annulus. The gas and particle streams are separated by the reactor cone 314, and the powder bed 315 which forces the hot process gas steam 316 into the central tube 307, to be ejected from the reactor through the gas ejector tube 317, and the powder is deposited in the calcined powder bed. The hot powder stream 317 is exhausted from the reactor by the exhaust valve 319, which may be a system of flap valves. Any powder in the gas stream 317 is extracted by a cyclone/filter system (not shown) and reinjected into the reactor.

The essential difference between FIGS. 1 and 3 is that in FIG. 3 there is a physical barrier to separate the gas and powder streams. It is noted that there is a tendency for the powder to preferably flow down near the outer wall of the reactor in FIG. 1 because it is know from fundamental principles that the gas particle friction is lowest in that region.

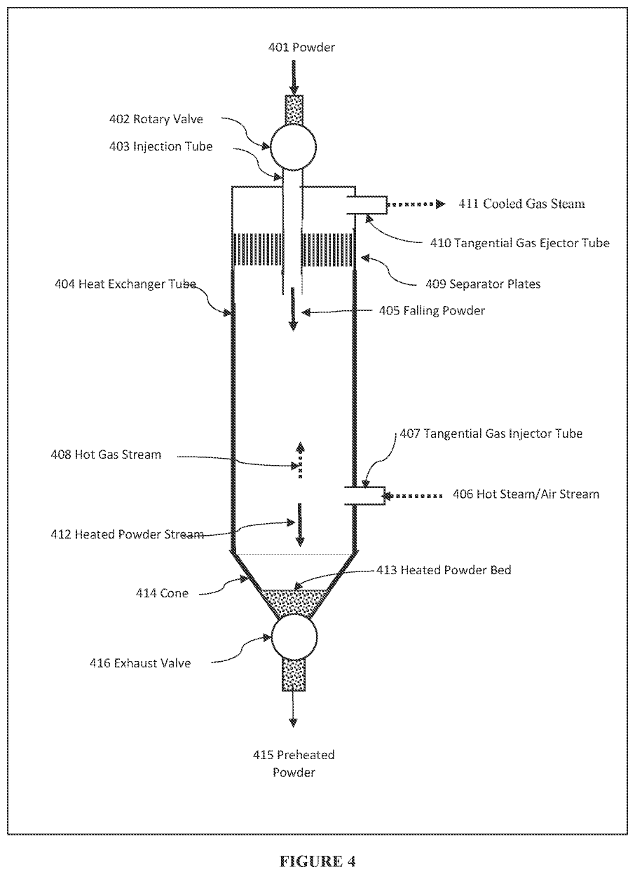

One relative advantage of the central tube in FIG. 3 is that the velocity of the rising gas stream maty be high so that the size of the cyclone at the top of the reactor for separation of the fines is smaller than an inertial separator; and particles are re-injected into the reactor at the top, whereas the efficiency of the large inertial separator at the base of the reactor is low, and a cyclone/filter is required to separate the fines. Another advantage is that the central tube can absorb radiation from the from the hot external tube, and this tube can re-radiate the energy to the gas-particle stream so the net heat transfer rate can be optimised. Another advantage is that the hot CO₂ stream exhausted from the top of the reactor can be used to partially preheat the input powder stream in say, a cyclone. This aspect is considered separately below with respect to integration optimisation. Another advantage of the central tube is that the extraction efficiency at the base can be enhanced by adding swirling elements near the end of the tube in the annulus and swirling elements of blades near the entrance of the inner tube in a way that both these elements create an additive flow pattern to the gas above the cone of the reactor base which enhances the separation efficiency of the particles and gas in the region below the central tube. Nevertheless, the gas particle separation at the base is sufficiently effective without either of these options. It is noted that the central tube of FIG. 3 may be perforated, or constructed from hanging segments, and that within that tube, blades may be used to swirl the gas so that any entrained powder may be extracted from that gas flow by an in-line ejector into the annulus. The embodiment of FIG. 3 may be preferred because it provides such options There are additional options for mitigating agglomeration and its associated impacts. The sintering of the particle reaction surfaces was considered above. One such surface is the external surface of the particle, and a reaction front is developed initially at this surface, so that this surface begins to sinter at the commencement of calcination so the propensity to bind particles reduces from that point. In many configurations of Direct Separation reactors, the particles are preheated before injection into those reactors. FIG. 4 shows an example embodiment in which the preheating process can be used to passivate, to a degree, the external particle surfaces by partly calcining and sintering the surface.

It would be understood by a person skilled in the art that the temperature at which calcination commences can be lowered by lowering the partial pressure of CO₂, and that the preheating of the powder can be managed using low-CO₂ gas streams such surface calcination commences in the preheater to a controlled degree. In FIG. 4, a pre-heating segment for preheating/calcining/sintering system is described. Powder feed 401 at a temperature below the calcination temperature, as described below, is injected by a rotary valve 402 into an injector tube 403 which delivers the particles into the refractory lined heat exchange reactor tube 404 to give an injected falling powder 405, in a plume. The hot steam/air stream 406 has a temperature sufficiently high, as described below, to preheat the powder, to induce calcination of the solids to limited degree, and to sinter the calcined particles is injected into the base of the system with a tangential gas injector tube 407 and flows upwards as a swirling gas flow 408. There is an exchange of heat between the rising gas and powder streams as they move in counterflow, and the system injection conditions are designed to reduce large scale turbulence which can optimise the heat transfer between the particles and the gas. The rising gas stream is exhausted through a system of separator plates 409 and a tangential gas ejector tube 410 to gas exhaust 411. Any powder in the cooled gas stream 411 is extracted by a cyclone/filter system (not shown) and reinjected into the reactor. The falling heated powder 412 forms a bed 413 in the cone 414. The hot powder exhaust 415 is exhausted from the system using an exhaust valve 416, which may be a system of flap valves. The temperature of the inputs and mass flow rates are such that the degree of calcination of the CaO material in preferably less than 10%, and most preferably less than 5%, and the residence time of the powder in the bed is such that the sintering of the powder in the powder stream 415 is such that the stickiness of the surface layer is such that the particles have a reduced tendency to agglomerate when injected into the calciners.

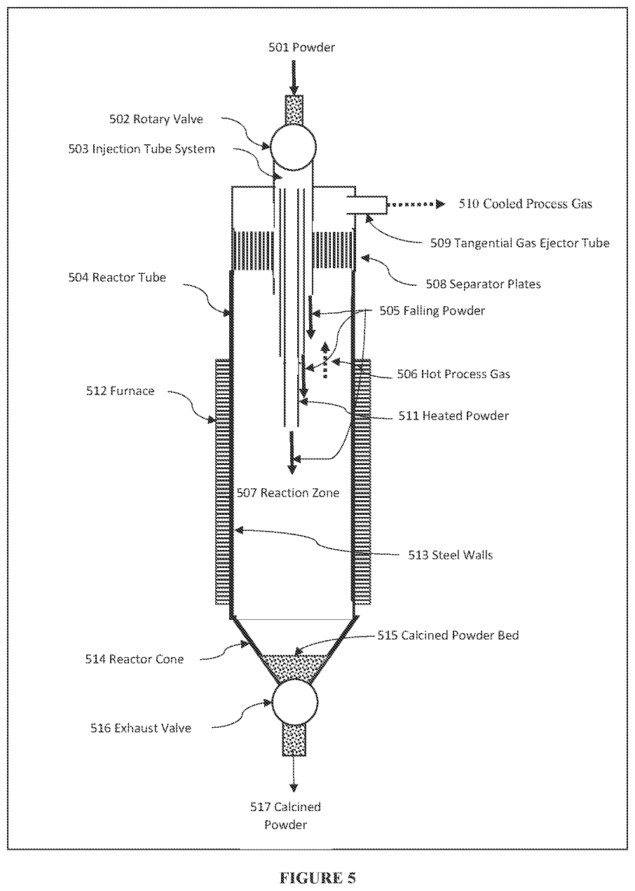

The sintering of the CaO on the surface can be accelerated by transferring the preheated powder in a portion of the hot CO₂ gas so that the catalytic sintering described above can be accelerated so that the powder is passivated to degree by the holding time of the powder in a feed hopper. In an alternative option is that a small amount of steam may be injected into the bed of the preheated pre-calcined particles to passivate the powder. Without being limited by theory, the sintering of CaO occurs more quickly in steam than CO₂, and the reaction of steam to form Ca(OH)₂ can be inhibited by maintaining the temperature of the material above about 580° C. In most cases, the preheating of the powder is limited by the energy available to about 720° C., so this condition may be met. The second feature of this embodiment is the injection of the preheated powder into the reactor at a number of points down the reactor. The intent of this approach is to lower the particle density at points higher in the reactor so that the agglomeration rate at those points in reduced. Such an embodiment is illustrated in FIG. 5, in which, a Direct Separator reactor with counterflow, similar to that of FIG. 1, is described in which a powder feed 501 is injected into the by a rotary valve 502 into an injector tube system 503 into the reactor tube 504. The reactor tube system in this embodiment comprises three concentric tubes compared to FIG. 1 which has one tube, The tubes have different lengths so that the powder is released into the reactor at different heights. The falling powder 505 from each such tube is heated towards the reaction temperature by the hot rising process gas stream 506 rising from the reaction zone 507 by gas-particle heat transfer by virtue of the counterflow. The cooled gas is separated from any entrained powder by a system comprising a system of separator plates 508 and a tangential gas ejector tube 509 to give a cooled process gas stream 510. Any powder in this gas stream is extracted by a cyclone/filter system (not shown) and reinjected into the reactor. The heated powder steams 511 from each tube in the reactor accumulates and fall slowly against the rising gas and enters the reaction zone 507 where it is heated by radiation from the reactor walls where the heat is generated within a furnace 512 which heats the steel walls 513 and the heat flows to the gas and particles in the reactor to induce the desired reaction. The length of the heating zone is sufficient for the reaction to be completed to the desired degree. The falling hot calcined powder is collected in the reactor cone 514 and forms a hot calcined powder bed 515 which is extracted from the reactor by an exhaust valve 516, which may be a system of flap valves to give the calcined powder stream 517.

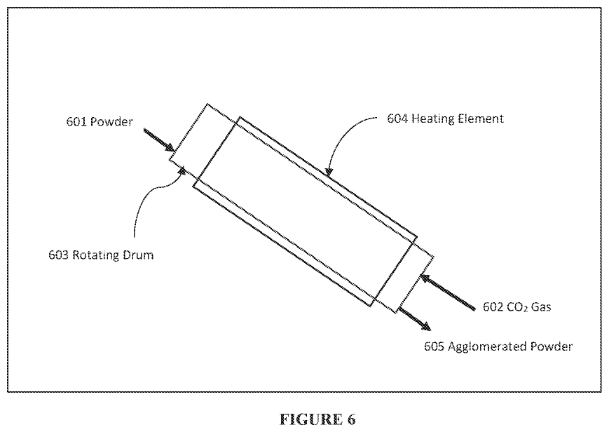

It is noted that the degree of inhibition of agglomeration achieved by sintering may be limited because the CO₂ or H₂O binds to the surface and facilitates fast surface migration of CaO at a sufficiently high temperature. This property may be used to manufacture new materials and applications for low emissions lime produced by Direct Separation reactors. It is noted that granules of limestone, or lime, are currently used in wide range of high temperature pyrolytic metallurgical process as a slagging agent, to remove silica and other impurities. Ground limestone was often used in these process, but the endothermic load from calcination of the limestone to CaO is very high, so that lime is commonly used. In these processes, fine lime powder is not used because the lime particles are entrained by the gas streams in such pyroprocesses, and lime granules of mm size are preferably used. The ability of Direct Separation reactors to make low emissions lime is of interest, but the particle size is limited, as explained above. However, from experimental observations, the fresh lime produced from these reactors may my readily balled into granules which may be heat treated to produce a granule with the strength required to be used in such processes. The example embodiment of FIG. 6 shows how such a process may be produce such granules. FIG. 6 is a granulator system in which a powder 601 and CO₂ containing gas 602 is injected into a heated rotary drum 603, which is heated by a heating element 604 to produce granules 605 at a sufficiently high temperature that the CaO is not recarbonated. A property of these granules is that they are inherently porous. Thus a second application is the use of such granules to capture gases such as SOₓ and CO₂ in a fixed bed, and the performance of these granules for such processes is enhanced by virtue of the fact that in the interior of the particle the reactivity of the CaO is higher than the lime made by conventional processes using high emissions lime. In another example, granules of CaO materials are strong, porous and permeable, and may be used absorb H₂O, SOₓ, CO₂, Cl₂, H₂S and other gases and metal vapours without cracking. In a further example, the high surface reactivity of the CaO may be used to produce granules of a mixture of powders. For example, the granule may be comprised of silicate containing minerals such as iron ore for the production of steel, or kaolin for the production of alumina, where the CaO in the granule may be used in a subsequent process, under appropriate conditions to form calcium silicates by a slagging process. For magnesium metal, the CaO containing material may be dolime, mixed with a reductant such as ferrosilicon, which when heated form magnesium vapour and a calcium-iron silicate slag. In all such cases the granules provide the close contact where the migration of CaO facilitates slag formation.

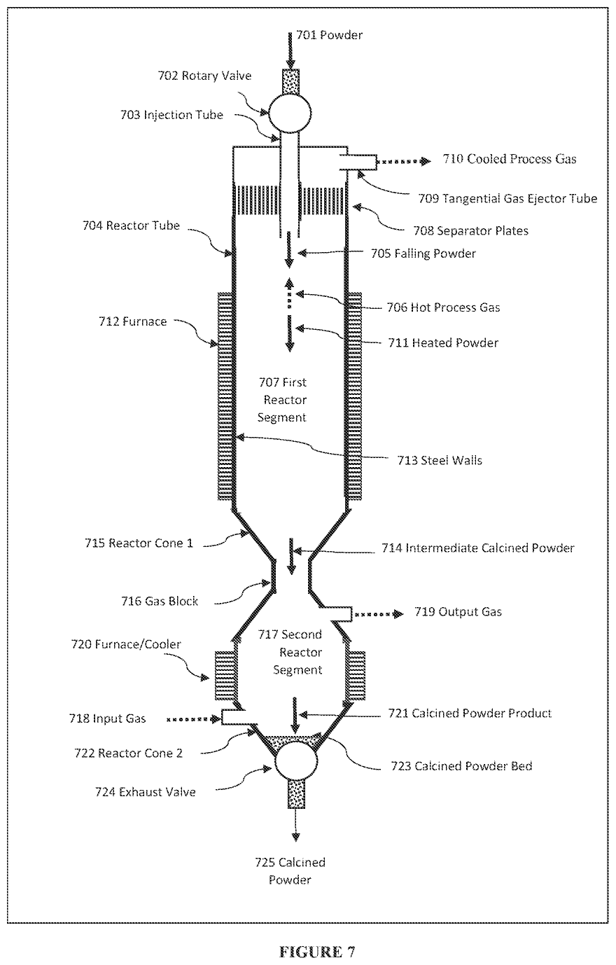

The prior art described above recognises that Direct Separation reactors may be segmented into different zones. One example is a post-processing segment in which the powder from a Direct Separation reactor is processed to complete the reaction process. It is understood that the residence time to complete a calcination reaction may very long because the reaction rate slows down as the reaction nears completion. There may be requirements for a very high degree of calcination for different products and applications. FIG. 7 describe embodiments that may be used to achieve a target for calcination in lieu of extending the length of the reactor. In FIG. 7, a general two segment Direct Separation reactor is described in which the first reactor segment is similar to that of FIG. 1 and the second reactor segment below the first is used to complete the calcination reaction by a number of different designs described below, and the two segments are separated by a gas block. The gas block operates by having a high mass flow of powder which, by virtue of the gas-particle friction substantially inhibits the flow of gas from the second segment to the first segment. The powder feed 701 is injected into the by a rotary valve 702 into an injection tube 703 into the reactor tube 704. The falling powder 705, in a plume, is heated towards the reaction temperature by the hot rising process gas stream 706 rising from the first reaction zone segment 707 by gas-particle heat transfer by virtue of the counterflow. The cooled gas is separated from any entrained powder by a system comprising a system of separator plates 708 and a tangential gas ejector tube 709 to give a cooled process gas stream 710. Any powder in this gas stream is extracted by a cyclone/filter system (not shown) and reinjected into the reactor. The heated powder 711 in the reactor falls slowly against the rising gas and enters the reaction zone where it is heated by radiation from the reactor walls where the heat is generated within a furnace 712 which heats the steel walls 713 and the heat flows to the gas and particles in the reactor to induce the desired reaction. The length of the heating zone is sufficient for the reaction to be completed to an intermediate desired degree, and the calcined intermediate powder 714 falls into the cone 715 where the powder is concentrated and flows into the gas block 716 to fall into the second reactor segment 717. A gas stream 718, with a composition depending on the materials and the mode of operation of this embodiment is injected into this reactor segment where it interacts with the powder and is exhausted from the reactor segment as stream 719. The efficiency of the gas block is set by the gas pressure drop across the two reactor segments. The temperature of the reactor segment walls may be controlled by the externally heated furnace or cooling segment 720 if required by the application. The desired reaction goes to completion in this segment to give a calcined power 721, which is collected in the reactor cone 722 and forms a hot calcined powder bed 723 which is extracted from the reactor by an exhaust valve 724, which may be a system of flap valves to give a calcined powder stream 725.

In the case of the production of CaO, where the reaction is incomplete, the temperature of the partially calcined powder 714 will be slightly above about 895° C. In one use of the embodiment of FIG. 7 CO₂ partial pressure in the first segment is about 103 kPa and is dropped to about 10 kPa by the injection of air or steam 718 so that the reaction recommences when the powder is transferred into the second segment. The calcination may go to completion by consuming the heat in the powder, or by applying additional heat as required from the furnace 720. The same considerations apply to the production of MgO. If steam is used the temperature must be maintained above the relevant hydration temperatures.

In another example of the system embodiment of FIG. 7, the second segment is used to sinter the intermediate material 714. In a specific example, the intermediate is MgO produced from the calcination of MgCO₃ as the feed 701, and the gas 718 is steam which in used to catalyse the MgO to give a desirable surface area of the MgO for industrial applications. Without the steam, the specific surface area may be grater than about 250-350 m²/g and with steam is can be reduced to less than about 10 m²/g.

In another example of the system embodiment of FIG. 7, the gas 718 may be a mixture of air, or oxygen, and a combustible material, generally a gas such as syngas, which reacts by flameless combustion to generate the heat for the reaction. This mode of operation is facilitated by the high temperature of the powder feed 714 which is preferably above the autoignition temperature of the combustible material.

It is noted that the second segment may be directly integrated into the first stage of the reactor by injecting the air and fuel into the base of a single segment reactor, in which case the concentration profile of the process gas increases as the gas rises in the reactor by the calcination reaction induced by the partial pressure drop, moderated by the interdiffusion of the gases.

In another example embodiment of FIG. 7, the gas 718 injected into the second segment have a component which reacts with the calcined intermediate powder 714 produced in the first segment. In this approach, the first segment is preferably operated to achieve a sufficiently high degree of calcination so that the reaction between the gas and the powder in the second segment may produce the desired calcined product 725. In addition, the mode of operation of the furnace/cooler 720 is set to established the required reaction conditions, for example providing heat for endothermic reactions or removing heat for exothermic reactions. A specific example is the case in which the calcined intermediate 714 is CaO from a precursor 701 of limestone, the injected gas 718 is steam, the furnace/cooling system 720 operates in a cooling mode such that the product 725 is hydrated lime, Ca(OH)₂. The heat recovered in 720 may be used in the overall process flow to reduce the energy demand required for the overall process. The same considerations apply to the production of Mg(OH)₂ from MgO.

A general example for the production of battery and catalyst materials is one in which the desired reaction is either a reduction or oxidation process of the intermediate 718 produced from a precursor 710, and which is accomplished by using an appropriate reducing or oxidation gas 718 and setting the temperature to induce the desired reaction for the desired product 725.

It would be appreciated by a person skilled in the art that the principles described by the example embodiment of the multisegment segment FIG. 7 may be applied to any calcination reaction, or pair of reactions, or sintering reactions, where the gas has a composition appropriate for the desired process.

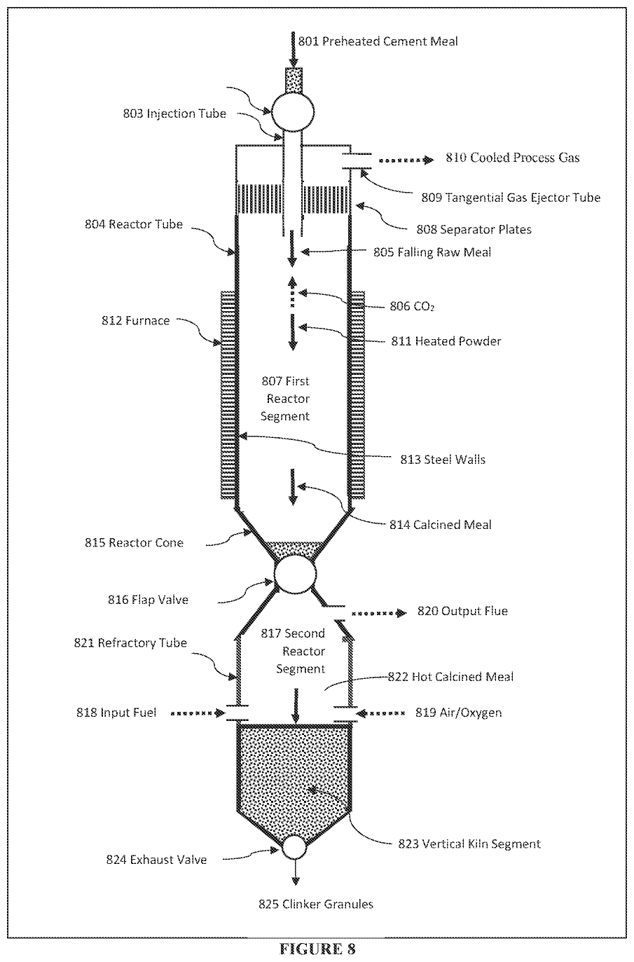

The process of Portland cement production occurs in several stages. The prior art described for Direct Separation reactors describes a process in which the initial stages of the process, namely the calcination of the cement raw meal is carried out in a Direct Separation reactor and the performance of that stage may be improved by the inventions described in this disclosure. The second stage is carried out in a rotary kiln where the calcined meal is injected into the kiln which is heated by a flame to about 1450° C. where the clinkerisation reactions that form belite and alite as the dominant cementitious materials are activated. It is noted that the thermal efficiency of a cement plant is typically about 60% or less because the heat losses from a rotary kiln are high, and the exothermic energy of the clinkerisation reactions is not used to advantage. The embodiment of FIG. 8 is directed to improvement of this process. This embodiment describes how the injection of a combustion gas and air/oxygen may be used to raise the temperature of the powder exhausted from a Direct Separation reactor by a homogenous combustion reaction. The application of the embodiment of FIG. 8 describes a process within a refractory lined segment in which the counterflow of the rising reacting air and fuel is used to heat the powder to a temperature of about 1260° C. or more. In FIG. 8, a specific two segment Direct Separation reactor is described for the production of clinker from preheated cement meal where an approach is taken to form clinker in a Direct Separation reactor segment. In this approach the option of using flap valves to separate the gas steams is used. The preheated cement meal 801, at about 720° C., is injected using a rotary valve 802 into an injection tube 803 for feeding into the reactor tube 804. The falling preheated powder 805, in a plume, is heated towards the reaction temperature by the hot rising CO₂ process gas stream 806 rising from the first reaction zone segment 807 by gas-particle heat transfer by virtue of the counterflow. The cooled gas is separated from any entrained powder by a system comprising a system of separator plates 808 and a tangential gas ejector tube 809 to give a cooled process gas stream 810, at about the same temperature as 801. Any powder in this gas stream is extracted by a cyclone/filter system (not shown) and reinjected into the reactor. The heated powder 811 in the reactor falls slowly against the rising gas and enters the reaction zone where it is heated by radiation from the reactor walls where the heat is generated within a furnace 812 which heats the steel walls 813 and the heat flows to the gas and particles in the reactor to induce the desired reaction. The length of the heating zone is sufficient for the reaction to be completed to an intermediate desired degree and the calcined cement meal powder 814 falls into the cone 815 where the powder is concentrated and is fed by a flap valve 816 to fall into the second reactor segment 817. A fuel stream 818 and an oxygen/air stream 819 is injected into this reactor segment where it undergoes flameless combustion and heats the powder 820. The reactor wall 821 is refractory tube. The combustion process heats the powder 822 to a temperature of about 1260° C. which marks the onset of the clinkerisation reactions to form belite. The hot particles fall into the vertical kiln segment 823, in a slowly moving bed where the particle-particle contacts allows these exothermic clinker reactions to proceed, and the heat released drives the temperature to about 1450° C. or more, where alite is formed when the residence time of the bed of about 30 minutes or less. The exotherm goes to completion in this segment to give a clinker granules. The exhaust valves 824 empties the hot clinker granules 825 from the vertical kiln, where they are cooled by air using conventional grating coolers (not shown). It would be appreciated by a person skilled in the art that FIG. 8 describes an energy efficient process because the exothermic reactions heat the meal, unlike the conventional kiln process which has a high heat loss.

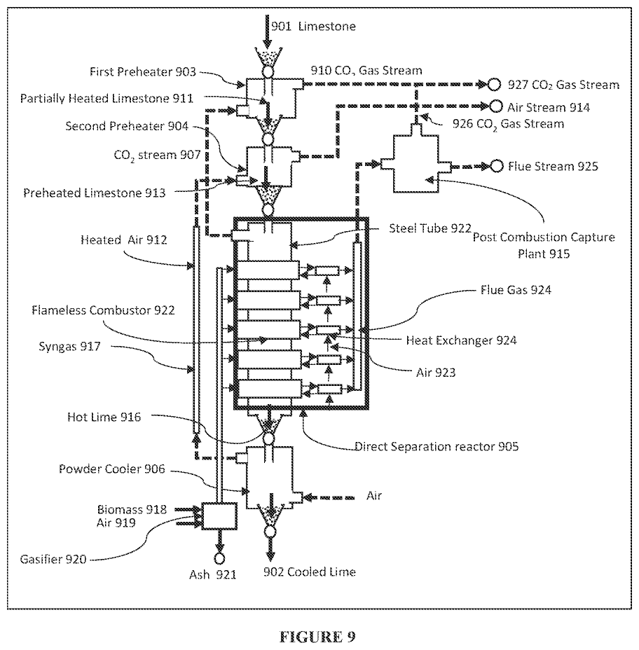

A high energy efficiency of an industrial process is an important factor. With regard to the reactor, the thermal energy efficiency for a given degree of calcination is not impacted by virtue of using a Direct Separation reactor. Any heat losses are associated with the heat losses through the refractory skin surrounding the furnace and combustor segments of the reactor. In this embodiment, the inventions are extended to a consideration of the combustor-furnace configuration. Important factors for heat transfer are the temperature and the convective heat exchange to the steel reactor walls and the refractory of the furnace, so that the radiation heat transfer through the steel walls is optimised. Generally, this is optimised by the known arts of using high gas velocities and a swirl of the gas. The Direct Separation reactors may be operated by using a separate combustor box and piping the hot flue gas into the furnace that surrounds the reactor tube in a way that gives these desirable properties, and the hot flue gas exhaust may be used to preheat the air for the combustion. However, the ducting and distribution of high temperature gases is not desirable. In FIG. 9, and example embodiment for the processing of limestone illustrates a different approach. The selected fuel is Syngas from Biomass and a postcombustion CO₂ capture system is used to illustrate a carbon negative product when the CO₂ stream is sequestered (not shown). In general terms, it is desirable to have a close integration of the combustor, the furnace and air recuperation processes to reduce the air volume required. The embodiment of FIG. 9 shows that array of recuperative flameless systems is may be applied to reduce the flue gas volume flow In such a system, the combustor and furnace are integrated, and the temperature of gas is uniform, from the absence of a flame, and the high velocity of the mixed gases. The thermal efficiency of a regenerative flameless combustor is very high, and the absence of a flame minimises the production of NOx. The use of a distribution of such systems allows the control of the temperature along the tube, which allows optimisation of the calcination process in the tube. In the embodiment of FIG. 9 a system, using a Direct Separation reactor is described which processes a limestone feed 901, ground to about a d₅₀ of 125 μm is processed to lime 902. The reactor system has three segments—a first powder preheater segment 903, a second powder preheater segment 904, a Direct Separation reactor segment 905 and a powder cooler segment 906. In the first powder preheater segment, the limestone process hot CO₂ stream 907 is injected into the base of a counterflow heat exchange refractory lined tube of the first powder preheat segment 903 into which the limestone powder 901, at ambient temperature is injected to give a cooled CO₂ gas stream 910 and a partially heated limestone 911 which is formed into a bed. The partially heated limestone 911 from the bed is injected into the top of a heat exchange refractory lined tube of the second powder preheat segment 904 where is heated by a hot air stream 912 from the powder cooler segment 906 described below and the preheated limestone 913 is formed into a bed. If required, the temperature of this air stream may be boosted by a duct heater (not shown) for the temperature of the preheated limestone is at or near the onset of calcination of limestone at about 930° C. The cooled air stream 914 is exhausted, but may be used (not shown) to supply low grade heat to the Post Combustion CO₂ capture system 915 for the flue gas described below. The preheated limestone 913 is injected into a Direct Separation reactor segment 905, here shown as a counterflow system of FIG. 1 to give a pure stream of processed CO₂ 907 which is ejected at about the temperature of the preheated limestone, and a hot lime powder 916. The Direct Separation reactor is heated by combustion of a hot Syngas stream 917 formed from biomass 918 and air 919 in a Gasifier 920. In the Gasifier, the Syngas the ash 921 is separated. The tars formed in the gasification process may be reinjected into the hot Syngas steam. The steel tube 922 of the Direct Separation reactor segment 903 is heated by the combustion of the hot Syngas by a number of regenerative flame combustion systems, one of which 922 injects air 923 which is preheated by the hot exhaust flue gas from the combustor in the heat exchanger 924 so that the flue gas steam 925 is cooled to give a high thermal efficiency combustion process. The CO₂ from that gas stream is injected into the Post Combustion CO₂ capture system 915 where the CO₂ 926 is extracted and mixed with the direct separation gas steam 910 to give the CO₂ steam 927 for compression and liquefaction (not shown).

The CO₂ emissions from fossil fuel combustion gases is a significant contribution to the CO₂ emissions intensity of a calcined product. For lime and cement, with typical solid fossil fuels such a coal, the combustion emissions is about 35% of the total emissions. One approach to reduce combustion emissions is to use a biofuel and, in combination with a Direct Separation reactor. Biofuels are generally solid fuels, called biomass, which may be gasified to Syngas using know art, and which may be used in the configuration of FIG. 9. An integrated gasification process gasification process is carried out using the know art of heating the biomass, in steam/air, to release the combustible volatiles and to separate and combust the ash, including the fly ash, with its residual carbon, to provide the heat for volatilisation in an indirectly heated process. The hot volatiles are combusted in a flameless combustor using preheated air. In this process, the gas may comprise syngas as well as tar precursors, because they are combusted. That is, the costly processes of removing the tar precursors is not required because the gas is maintained above the tar condensation process, so the fuel is not only preheated, but has a higher LHV for combustion. The removal of the fly ash from the gas stream is performed to minimise the formation of glassy deposits of silica on the steel walls of the furnace. The Post Combustion capture process in FIG. 9 may use either amines, bicarbonates or hydrotalcites.

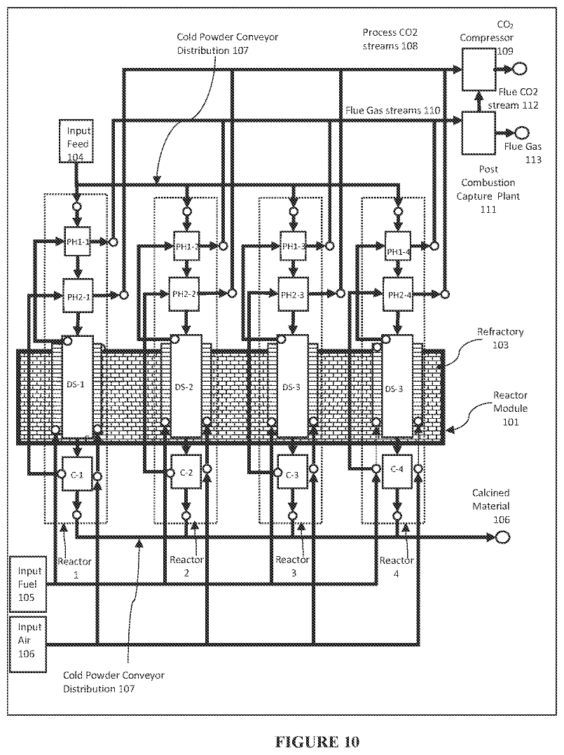

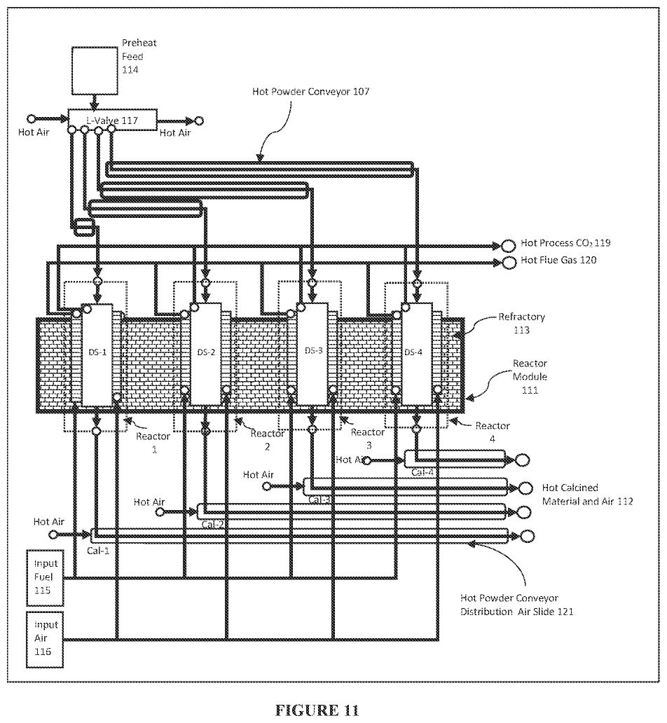

The embodiments described above, and exemplified by the examples of FIGS. 1-9 are associated with reactor based on a single tube. The scale up of the processing by expanding the diameter of reactor is limited by the absorption of heat from the hot walls by the particles and the process gas, and the mass flow is limited by the capacity of the walls to transfer heat and the engagement of the particles in the process gas which impacts on the residence time of the particle in the reactor tube. Generally, the mas flow through the reactor with a diameter of about 2 m is in the range of 5-10 tonnes/hr. The height of the reactor depends on the kinetics of the process and the heat transfer rate from the walls, and is typically 10-30 m. It follows that the scale up of the process is to increase the number of tubes. However, there are innovations associated with the design of an array of reactor tubes, and these are described herein. FIG. 10 is an example embodiment of a scaled up system in which the tubes, shown as four in the embodiment, are assembled into a furnace in which the amount of refractory between the tubes is minimised so that any tube can be shut down with minimal impact on adjacent tubes. The temperature of the non-operating tube is sufficiently low that there is no risk of distortion of that tube, and the set points of the operating tube may be adjusted to maintain the degree of calcination of the product and other process variables. This condition may be achieved in the module so that any tube may be in operation, and the process flow in each tube may be varied with a tolerable, known thermal coupling between the tubes. In the embodiment of FIG. 10, the refractory may be constructed from stacked cast blocks that provide to the integration into the input fuel gas and flue gas distribution systems of the module, and flameless combustors are shown. The cast blocks are designed so as to minimise the refractory mass, and the cost of construction and replacement. In this embodiment, each tube has its own preheating and post-processing systems to minimise the transport of hot gases and powders. The embodiment of FIG. 10 is a schematic of a reactor module of 102 of four Direct Separation Reactors 1,2,3,4 which are integrated into a refractory 103. This system is based on a concept that conveying cold powders and cold gas steam are a known art with the costs and challenges being reduced by lowest temperature of these process flows. The embodiment shows in input of ambient powder 104, a source of gaseous fuel 105 and ambient air 106. The direct separation reactor are based on the embodiment of FIG. 1 and the combustors of FIG. 9. Thus the input powder is conveyed by cold powder conveyors 107 from the hopper 104 into each Reactor through separate lines to the respective Stage 1 Preheaters PH1-1,2,3,4 which cool the process CO₂ 108 from each Direct Separator reactor segment DS-1,2,3,4, and are directed to the central CO₂ clean/up compressor system 109. The flue gas 110 from the reactor combustors, after recuperation with the incoming air streams, are directed to the post-combustion capture plant 111 to give a combustion CO₂ stream 112, which then compressed, and a flue gas. In the case of the production of cement meal, the hot the powder streams from each reactor may be transferred to a rotary kiln by the air slides described in the embodiment of FIG. 11 below.

A number of modules as described in FIG. 10 may be used for further scale up. An advantage of this approach is that any tube which may be rendered inoperable may be replaced while the other tubes can continue to operate, and also that such tubes may be commissioned and its operations can be optimised at each stage of preheating, calcination and cooling to deliver a calcined product to meet specifications.

There are scale up gains that may be made in which the ancillaries that are used to preheat and postprocess the powders and gas steams may be scaled into single modules. While such an approach requires distribution of hot gases and powders, there are a number of approaches that may be used to achieve the benefit of such scaling. Such a system is shown in FIG. 11 in which a module of four tubes has a single preheater stack so that the preheated powder is uniformly distributed to the tubes using a 1:4 L-valve distribution system with controls to allow any number of tubes to be fed; the calcined powder streams are collected using a 4:1 heated air slide system which have similar controls; and the hot CO₂ streams are combined to give a single CO₂ steam for postprocessing and compression. Such a heat recuperation system is known to scale from the use of suspension cyclones in cement plants. In this embodiment the heat in the combined CO₂ stream is used to preheat the powder in the first stage of a cyclone stack. For the production of cement, the hot air slide would deliver the hot calcined meal to a single rotary kiln (not shown). The embodiment of FIG. 11 is a schematic of a system that uses a reactor module of 111 of four Direct Separation Reactors 1,2,3,4 which are integrated into a refractory 113. This system is based on a concept that conveying hot powders and hot gas steams are a known arts, with the higher costs and challenges for these elements being offset by the use of large scale preheaters and coolers rather than, in the embodiment of FIG. 10 where each reactor required an separate systems. The embodiment shows in input of preheated powder 114, a source of gaseous fuel 115 and ambient air 116. The direct separation reactor are based on the embodiment of FIG. 1 and the combustors of FIG. 9. In the case of hot powders, a means of controlling the flow rate into each tube is through the use an L-valve fluidised bed 117 fluidised by hot air 118, and the heat each loss in each conveyor tube is minimised by a refractory pipe. The conveyor system for the preheated powder for each tube, if pneumatic, is steeply inclined to avoid saltation. Each reactor DS1, DS2, DS3, DS4 generates a hot process CO₂ stream which is aggregated to a hot CO₂ stream 119, and a hot flue gas stream 120 which are conveyed to a central preheater for the powder through refractory coated pipes (not shown). The calcined powder streams Cal1, Cal2, Cal3 and Cal4 from each tube are conveyed by a system of tubes, and one example, the conveying is achieved by a refractory enclosed, inclined hot air slide 121. The aggregated hot calcined materials 122 are generally injected into to a powder cooling system (not shown) or, in the case of cement production, a rotary kiln system.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A system for calcination of a powder material comprising a plurality of vertical reactor tubes in which a falling powder is heated within a heating zone by radiation from one or more externally heated walls of the reactor tubes, in which the calcination process of the powder is a reaction which liberates a gas, or induces a phase change; wherein an average velocity of the particles of the falling powder during its transit through the reactor tubes is 1.0 m/s or less; a flux associated with the powder material for each tube is in a range of 0.5-1 kg m-2 s-1, and wherein a length of the heating zone is in a range of 10 to 35 m.

2. The system according to claim 1, wherein the powder material comprises one or more compounds or minerals which when heated, liberates a gas, wherein the gas is at least one selected from the group of: carbon dioxide, steam, an acid gas such as hydrogen chloride, and an alkali gas such as ammonia.

3. The system according to claim 2, in which the mineral is limestone or dolomite.

4. The system according to claim 3, in which the compounds include silica and clays, such that the powder material is a raw cement meal for the manufacture of Portland cement.

5. The system according to claim 1, in which a particle volume distribution of the powder material is limited by 90% less than 250 μm diameter and 10% higher than 0.1 μm.

6. The system according to claim 1, in which the liberated gas flows upwards in the tube against the flow of the calcining powder material and wherein the gas is exhausted at a top of the system.

7. The system according to claim 1, in which the liberated gas, and any gas introduced into the system flows downwards in the reactor tube with the flow of the calcining powder and wherein the gas is exhausted at a base of the system.

8. The system according to claim 1, in which an inner tube is placed in each tube and the powder material flows downwards in a reaction annulus with the liberated gas; and wherein at a base of the reactor, the gas flow is reversed to flow up through the inner tube and the liberated gas and any gas introduced into the system is exhausted at a top of the system.

9. The system according to claim 1, in which the powder material entrained in any exhausted gas liberated by the calcification process is separated and reinjected into the system.

10. The system according to claim 9, in which the injected powder is preheated in a gas-powder preheater system prior to injection into the system.

11. The system according to claim 10, in which the gas-powder preheater system is one or more refractory heating tubes in which the cold powder material falls through a hot rising gas and is heated by the hot rising gas, in which average velocity of the powder during its transit through a preheater tube is 0.5 m/s or less.

12. The system according to claim 9, in which an exhausted powder from a base of the system is cooled in a gas-powder cooling system.

13. The system of claim 12, in which the gas-powder cooling system is one or more refractory cooling tubes in which any hot powder material falls through a cool rising gas, in which average velocity of the powder material during its transit through a cooling tube is 0.5 m/s or less.

14. The system according to claim 1, in which an external heating system for externally heating the walls of the tube is an integrated combustor and furnace system which enables control of a temperature profile down the heating zone of the system.

15. The system according to claim 14, in which the external heating system is a flameless combustion system which enables the control of the temperature profile down the heating zone of the system.

16. The system according to claim 14, in which a fuel for the external heating system is at least one gas selected from the group of: natural gas, syngas, town gas, producer gas, and hydrogen; and wherein a gas used for combusting the fuel is air, oxygen or mixtures thereof which have been heated from flue gases of the external heating system.

17. The system according to claim 16, in which CO2 in the flue gases is extracted using a regenerative post-combustion CO2 capture system, which includes at least one substance selected from the group of: an amine sorbent system, a bicarbonate sorbent system, and a calcium looping system.

18. The system according to claim 14, in which the external heating system is an electrically powered furnace, where the electrical power is generated from hot gas streams in a production plant of which the system is a part, or extracted from an electricity grid, and configured to enable the control of a temperature profile down the heating zone of the system.

19. The system according to claim 14, in which the external heating system includes a plurality of heating subsystems, with the heating subsystems being associated with different segments of each tube or different tubes, and the operation of the system can use a variable combination of such external heating subsystems while maintaining a continuous production of calcined materials.

20. The system according to claim 1, in which the powder material is injected into the reactor tubes at a number of depths.

21. The system according to claim 1, in which each tube is segmented into a plurality of segments mounted in series, in which any gases liberated or introduced in each segment are withdrawn from that segment using a gas-block between segments.

22. The system according to claim 21, in which a partial pressure of the gas liberated during the calcination in a higher segment may be reduced in a lower segment located below the higher segment, so that the reaction proceeds further by a partial pressure drop to a lower partial pressure so as to achieve a new equilibrium at the lower partial pressure, including a drop in a wall temperature of the lower segment so that any thermal energy stored in the partially calcined powder from the higher segment is used for calcination.

23. The system according to claim 21 wherein a wall temperature of each segment increases sequentially in each segment from an upper segment so that any gas liberated from each segment can be a specific gas of a desired purity, and other gases may be added to each segment to promote catalysis of the reaction step or sintering of the materials during the reaction step.

24. The system according to claim 23, wherein the system makes sintered MgO for refractory blocks from magnesite.

25. The system according to claim 23, wherein the system produces Ca(OH)2 or Mg(OH)2 from limestone or magnesite.

26. The system according to claim 23, wherein the system controls an oxidation state of battery precursors.

27. The system according to claim 1, in which each tube is segmented into a number of segments, in which any gases liberated or introduced in each segment are withdrawn from that segment using a gas-block between segments, and a hot gas stream is introduced into a segment to boost a thermal energy of the gas and particles in that segment to augment a thermal energy provided by external heating.

28. The system according to claim 27, in which the gas stream in a segment contains a combustible fuel and oxygen or air for combustion to induce combustion in that segment to boost the thermal energy of the gas and particles in that segment to augment the thermal energy provided by external heating in that or other segments.

29. The system according to claim 27, in which the temperature rise from combustion is sufficient to induce particle-particle or intraparticle reactions typical of roasting or clinkering reactions which subsequently occur in a powder bed formed at a base of a segment wherein the energy released from exothermic reactions can sustain or increase the temperature of the powder bed so that the induced reactions are sufficiently complete during the residence time in the powder bed.

30. The system according to claim 10, in which a preheating temperature of the gas-powder preheater system is in a range of 650 to 800° C., and a partial pressure of the gas liberated during calcination is below 15 kPa, so that the powder material is partly calcined and then sintered such that a surface energy of an associated particle is reduced sufficiently so that a propensity of the particles to subsequently bind and agglomerate is reduced.

31. The system according to claim 1, in which the material is limestone where the calcined material, or mixtures of calcined material with other minerals, is introduced into a post-processing system to produce granules of the materials, in which the granules are formed by agitating the powders and wherein the gas environment contains carbon dioxide, in which a temperature of a granulator system included in the post-processing system is in a range of 650 to 800° C. that recombination of lime associated with the limestone with CO2 is suppressed.

32. The system according to claim 1, in which the material is to be first calcined in a first segment using steel reactor walls to provide heat to the system and the gas liberated or introduced in each segments is withdrawn from that segment using a gas-block between this first segment and a lower segment, so that a second gas stream of a different gas may be injected into the lower segment and heat transfer through a reactor wall in the second lower segment is controlled so that the calcined powder from the first segment reacts with the gas to produce a new material compound.

33. The system according to claim 32, in which the powder material is limestone, CaCO3, or dolomite CaCO3·MgCO3, in which the calcined product from the first segment is lime CaO or dolime CaO·MgO and wherein the exhausted gas is CO2, and the gas injected into the second segment is steam H2O and the temperature is controlled by the removal of heat through the wall so that hydrated lime is exhausted from the second segment and a diameter of the tubes in the system is selected such that a residence time allows associated heat transfers and reaction kinetics to be balanced with a substantially reduced segment length.

34. The system according to claim 33, in which the hydrated lime or dolime product has a high reactivity with CO2 in ambient air to reform CaCO3 or MgCO3·CaCO3, and where this product is reintroduced into the system so as to remove CO2 from ambient air in a cyclic system, and wherein when the product is used with renewable fuels and with combustion CO2 capture, the system produces a carbon negative emissions product.

35. The system according to claim 1, in which the reactor tubes are vibrated to remove a build-up of solid materials adhered to the walls of the system.

36. The system according to claim 1, in which heat from the external heating system to each tube is separated by a refractory wall such that a plant including the system can operate with any number of tubes in an efficient manner through the use of refractory materials and energy distribution, including gas and radiation, which controls an exposure of any tube to radiation and convection transfer of heat so that a temperature profile is controlled within desirable limits linked to thermal stresses of the metal tube, and energy consumption by the system.

37. The system according to claim 36, in which a preheater segment and/or one or more cooling segment requires a distribution of preheated materials from a central preheater to each tube which is accomplished by at least one of the group of: an L-valve, an assembly of L-valves designed to provide a controlled distribution of powder to each tube, an aggregator system of the hot calcined materials from each tube to a central cooling system, and a central subsequent processing system such a kiln where the aggregation is accomplished by a system of gas-slides where the flows of hot calcined powder are controlled to provide a continuous flow of materials.
